(19) United States
(12) Patent Application Publication
(10) Pub. No.: US 2022/0050979 A1
(43) Pub. Date: Feb. 17, 2022

(54) STORE APPARATUS, STORE SYSTEM, CHECKOUT METHOD, AND PROGRAM

(71) Applicant: NEC Corporation, Minato-ku, Tokyo (JP)

(72) Inventors: Kazuki MIURA, Tokyo (JP); Maya TAKABATAKE, Tokyo (JP)

(73) Assignee: NEC Corporation, Minato-ku, Tokyo (JP)

(21) Appl. No.: 17/435,476

(22) PCT Filed: Feb. 10, 2020
(86) PCT No.: PCT/JP2020/005129

§ 371 Date: Sep. 1, 2021

(30) Foreign Application Priority Data
Mar. 4, 2019 (JP) 2019-038667

(51) Int. Cl. G06K 7/10; G07G 1/12; G07G 1/00; G06Q 20/20; G07C 9/00; G07C 9/28

(52) U.S. Cl. CPC G06K 7/10445; G06K 7/10297; G07G 1/12; G07C 9/28; G06Q 20/209; G06Q 20/208; G07C 9/00658; G07G 1/0009

(57) ABSTRACT

A store apparatus (10) includes a reading result registration unit (110) that registers a tag reading result including tag recording information acquired by reading a tag provided to an individual product by a reading apparatus of a gate and radio wave intensity received from the tag, in association with person determination information about a person who passes through the gate, a purchase product confirmation unit (120) that confirms a purchase product, based on the tag reading result for each person, and a checkout unit (130) that performs checkout processing of the purchase product confirmed by the purchase product confirmation unit (120). When tag recording information related to a same tag is included in both of a first tag reading result related to a first person and a second tag reading result related to a second person who passes through the gate after the first person, the reading result registration unit (110) confirms the first tag reading result, based on magnitude of intensity of a radio wave received from the same tag.

### TECHNICAL FIELD

The present invention relates to a technique for assisting with accounting processing at a store.

### BACKGROUND ART

One example of a technique related to a system for collectively reading a product in a cart by installing, at an accounting place of a store, a gate including an antenna that reads a wireless tag provided to a product and by passage of a customer together with the cart including the product therein through the gate is disclosed in PTL 1 described below. A technique for correcting, in order to prevent registration of a false product due to reception of a signal from a wireless tag provided to a product by antennas at a plurality of gates, a reading result of the wireless tag at each of the gates, based on reception intensity of a signal by each of the antennas, is disclosed in PTL 1.

### CITATION LIST

### Patent Literature

[PTL 1] Japanese Patent Application Publication No. 2010-250694

### SUMMARY OF INVENTION

### Technical Problem

There is also a case where, at a product reading gate as disclosed in PTL 1, a purchase product of a person who waits for a previous person to pass through the gate is recognized by mistake. In the technique of PTL 1 described above, false recognition of the product in this case cannot be prevented.

The present invention has been made in view of the above-described problem. One of objects of the present invention is to provide a technique for preventing false recognition of a product at a gate that recognizes the product by using a tag.

### Solution to Problem

A store apparatus according to the present invention, including:

a reading result registration unit that registers a tag reading result including tag recording information acquired by reading a tag provided to an individual product by a reading apparatus provided at a gate and intensity of a radio wave received from the tag, in association with person determination information that determines a person who passes through the gate;

a purchase product confirmation unit that confirms a purchase product, based on the tag reading result for each person;

a checkout unit that performs checkout processing of the confirmed purchase product; and

an electronic receipt issuing unit that issues an electronic receipt for the checkout processing, wherein,

when tag recording information related to a same tag is included in both of a first tag reading result related to a first person and a second tag reading result related to a second person who passes through the gate after the first person, the reading result registration unit confirms the first tag reading result, based on magnitude of intensity of a radio wave received from the same tag.

A store system according to the present invention, including:

a gate including a reading apparatus that reads a tag provided to an individual product;

a reading result registration unit that registers a tag reading result including tag recording information acquired by reading a tag provided to an individual product by a reading apparatus provided at a gate and intensity of a radio wave received from the tag, in association with person determination information that determines a person who passes through the gate;

a purchase product confirmation unit that confirms a purchase product, based on the tag reading result for each person;

a checkout unit that performs checkout processing of the confirmed purchase product; and

an electronic receipt issuing unit that issues an electronic receipt for the checkout processing, wherein,

when tag recording information related to a same tag is included in both of a first tag reading result related to a first person and a second tag reading result related to a second person who passes through the gate after the first person, the reading result registration unit confirms the first tag reading result, based on magnitude of intensity of a radio wave received from the same tag.

A checkout method according to the present invention, including:

by a computer,

registering a tag reading result including tag recording information acquired by reading a tag provided to an individual product by a reading apparatus provided at a gate and intensity of a radio wave received from the tag, in association with person determination information that determines a person who passes through the gate;

confirming, when tag recording information related to a same tag is included in both of a first tag reading result related to a first person and a second tag reading result related to a second person who passes through the gate after the first person, the first tag reading result, based on magnitude of intensity of a radio wave received from the same tag;

confirming a purchase product, based on the tag reading result for each person;

performing checkout processing of the confirmed purchase product; and

issuing an electronic receipt for the checkout processing.

A program according to the present invention causing a computer to execute:

registering a tag reading result including tag recording information acquired by reading a tag provided to an individual product by a reading apparatus provided at a gate and intensity of a radio wave received from the tag, in association with person determination information that determines a person who passes through the gate;

confirming, when tag recording information related to a same tag is included in both of a first tag reading result related to a first person and a second tag reading result related to a second person who passes through the gate after the first person, the first tag reading result, based on magnitude of intensity of a radio wave received from the same tag;

confirming a purchase product, based on the tag reading result for each person;

performing checkout processing of the confirmed purchase product; and

issuing an electronic receipt for the checkout processing.

### Advantageous Effects of Invention

The present invention provides a technique for preventing false recognition of a product at a gate that recognizes the product by using a tag.

### BRIEF DESCRIPTION OF DRAWINGS

The above-described object, the other objects, features, and advantages will become more apparent from suitable example embodiments described below and the following accompanying drawings.

FIG. 1 is a diagram illustrating a configuration of a store system according to a first example embodiment.

FIG. 2 is a block diagram illustrating a hardware configuration of a store apparatus.

FIG. 3 is a sequence diagram illustrating a flow of processing performed by the store system according to the first example embodiment.

FIG. 4 is a diagram illustrating a state in a storage region after a first person passes through a gate.

FIG. 5 is a diagram illustrating a state in the storage region after a second person passes through the gate.

FIG. 6 is a diagram illustrating a state in the storage region after a first tag reading result is corrected.

FIG. 7 is a diagram illustrating a state in the storage region after the second person passes through the gate.

FIG. 8 is a diagram illustrating a state in the storage region after a second tag reading result is corrected.

FIG. 9 is a diagram illustrating a state in the storage region after the second person passes through the gate.

FIG. 10 is one example of information that defines a correspondence between each product and an RF tag.

FIG. 11 is a flowchart illustrating a flow of processing performed by a store apparatus according to a second example embodiment.

FIG. 12 is a flowchart illustrating a flow of processing performed by a store apparatus according to a third example embodiment.

FIG. 13 is a diagram illustrating a configuration of a store system according to a modification example of the third example embodiment.

FIG. 14 is a flowchart illustrating a flow of processing performed in the modification example of the third example embodiment.

FIG. 15 is a diagram illustrating one example of a screen displayed on a terminal after issue of an electronic receipt.

### EXAMPLE EMBODIMENT

Hereinafter, example embodiments of the present invention will be described by using drawings. Note that, in all of the drawings, a similar component has a similar reference sign, and description thereof will be appropriately omitted. Further, in each block diagram, each block represents a configuration of a functional unit instead of a configuration of a hardware unit unless otherwise described. Further, a direction of an arrow in the drawings is used for facilitating understanding of a flow of information, and does not limit a direction (one-way communication/two-way communication) of communication unless otherwise described.

### First Example Embodiment

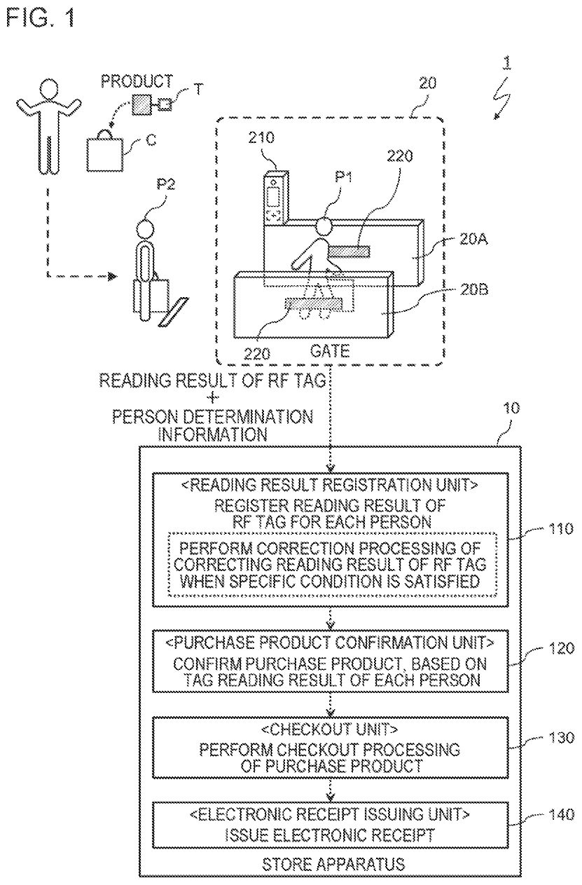

FIG. 1 is a diagram illustrating a configuration of a store system 1 according to a first example embodiment. As illustrated in FIG. 1, the store system 1 is configured to include a store apparatus 10 and a gate 20.

### Flow of Basic Checkout Processing

In the store system 1 illustrated in FIG. 1, checkout processing having a flow as follows is performed.

First, a person (customer) who comes to a store puts a product to be purchased into a container C (such as a shopping bag, a basket, or a cart). Herein, a radio frequency (RF) tag T for radio frequency identification (RFID) is provided to an individual product. The RF tag T is also referred to as an integrated circuit (IC) tag and an electronic tag. The RF tag T may be a passive tag, and may be an active tag. For example, a passive RF tag acquires operating power by receiving a radio wave from a tag reading apparatus 220, codes information in the RF tag, and sends the coded information to the tag reading apparatus 220. Further, an active RF tag codes information in the RF tag with a built-in power supply as electric power, and sends the coded information to the tag reading apparatus 220. Herein, the RF tag T stores identification information unique to an individual. A plurality of products of the same type (two or more products having the same product identification information such as a Japan article number (JAN) code) can be individually recognized by using the RF tag T.

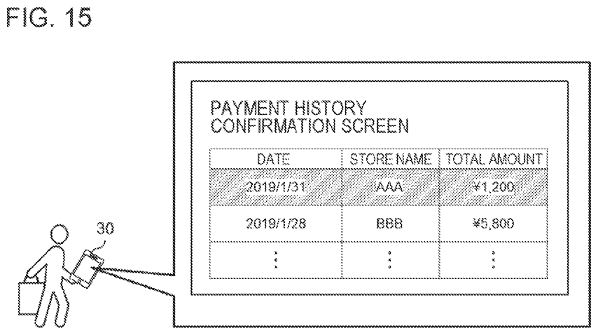

Before coming to a store, a customer installs a special application installed in a terminal 30 of the customer, and completes initial setting. For example, personal information about a customer and a face image of the customer are registered. The registered personal information includes, for example, a name, an address, a phone number, and a payment method (such as a credit card number, a debit card number, an electronic money checkout type, and an account number for automatic direct debit). Note that, a face images of a customer may be registered by capturing in a special terminal at a store. A customer who visits a store puts a product to be purchased into the container C, and then passes through the gate 20 with the container C. When a person passes through the gate 20, the RF tag T provided to the product in the container C is read, and the purchase product of the customer is recognized in the store system 1. Then, when the purchase product of the customer is confirmed via processing described below in detail, payment processing of a product price is performed by using information (such as information about a credit card and information about a direct debit account) about a payment method associated with the person. Subsequently, an electronic receipt including information about a purchase product, information about a payment price, and the like is transmitted to the terminal 30 possessed by the customer. When the terminal 30 receives the electronic receipt, the terminal 30 notifies, by sound, vibration, screen display, and the like, that the electronic receipt is received. When a response (for example, a touch on display on a screen, and the like) is made to the notification on the terminal 30, a screen as illustrated in FIG. 15 described later is displayed on the terminal 30. FIG. 15 is a diagram illustrating one example of a screen displayed on the terminal 30 after issue of an electronic receipt. A customer can view an electronic receipt indicating a content of checkout processing by operating the screen.

### Functional Configuration of Gate 20

The gate 20 includes a person determination information acquisition apparatus 210 that acquires information (hereinafter, also expressed as “person determination information”) for determining a person who passes through the gate 20, and the tag reading apparatus 220 for reading an RF tag provided to an individual product to be purchased by the person.

As one example, the person determination information acquisition apparatus 210 is configured to include a camera module. In this case, the person determination information acquisition apparatus 210 is installed in a state where a position and an orientation are adjusted in such a way as to be able to generate an image (hereinafter, also expressed as a “face image”) including a face of a person P (customer) who enters the gate 20. The person determination information acquisition apparatus 210 acquires, as person determination information, a face image generated by the camera module. The face image is used for face authentication processing of a person who passes through the gate 20. In the face authentication processing, whether a person is registered in advance is determined by performing matching for a face image of a person (for example, a member of a store, and the like) registered in advance. Note that, the face authentication processing may be performed by the person determination information acquisition apparatus 210, and may be performed by a not-illustrated server apparatus.

As another example, the person determination information acquisition apparatus 210 is configured to include a card reader module that reads a card (for example, a credit card, an electronic money card, a store member card, and the like) including information that can uniquely determine a person (customer). In this case, the person determination information acquisition apparatus 210 acquires person determination information stored in each card via the card reader module. Then, processing of verifying the person determination information acquired by the person determination information acquisition apparatus 210 with information (card information) about each person registered in advance, and authenticating an individual is performed. Note that, the authentication processing may be performed by the person determination information acquisition apparatus 210, and may be performed by a not-illustrated server apparatus.

As another example, the person determination information acquisition apparatus 210 is configured to include a code reader module that reads a code symbol (a one-dimensional code and a two-dimensional code) in which information that can uniquely determine a person (customer) is encoded. In this case, the person determination information acquisition apparatus 210 acquires, by an application installed in a portable terminal such as a smartphone, for example, person determination information from a code symbol displayed on a screen of the portable terminal and a code symbol printed on a medium such as paper. Then, processing of verifying the person determination information acquired by the person determination information acquisition apparatus 210 with information (for example, a user ID issued at a time of application installation, and the like) about each person registered in advance, and authenticating an individual is performed. Note that, the authentication processing may be performed by the person determination information acquisition apparatus 210, and may be performed by a not-illustrated server apparatus.

When the authentication processing using the person determination information described above is successful, the authenticated person is permitted to pass through the gate 20. For example, when the authentication processing is successful, a not-illustrated door on an entrance side of the gate 20 is open. In addition, when a not-illustrated notification apparatus (such as a speaker, a display, and a lamp) is provided at the gate 20, and the authentication processing is successful, the notification apparatus may be configured to aurally or visually notify permission of passage.

Note that, the person determination information acquisition apparatus 210 may be configured in such a way as to include a combination of the plurality of modules illustrated herein. Further, although not illustrated, the person determination information acquisition apparatus 210 may be provided as a single apparatus separated from the gate 20 in a position different from the gate 20. For example, the person determination information acquisition apparatus 210 may be provided in a position (for example, a region between an entrance of the gate 20 and a waiting place, and the like) slightly away from the gate 20, an entrance of a store, and the like.

As a specific example, a case where the person determination information acquisition apparatus 210 including the camera module is provided at an entrance of a store is considered. In this case, the person determination information acquisition apparatus 210 can acquire person determination information about a person captured in an image generated by the camera module by performing face authentication and the like by using the image. Further, in this case, the store apparatus 10 can recognize a correspondence between a tag reading result and determination person information by comparing timing (time) at which the person who comes near the gate 20 with timing (time) at which an RF tag (product) is read in the tag reading apparatus 220. Note that, the timing at which a person comes near the gate 20 is recognized by tracking the person by using an image of a camera installed in a store. For example, the store apparatus 10 tracks a recognized person by using a known algorithm that generates a path of flow of a person, and can determine that the “person comes near the gate 20” when a difference between a terminal (current position) of the path of flow of the person and a reference position (for example, a position of an entrance) of the gate 20 becomes less than a predetermined threshold value.

The tag reading apparatus 220 is provided on side wall portions (portions indicated by reference signs 20A and 20B in the drawing) of the gate 20. Note that, the side wall portions 20A and 20B of the gate 20 are provided at a width through which the container C and a person can pass at the same time. The tag reading apparatus 220 communicates with the RF tag T provided to each product, and acquires information (hereinafter, also expressed as “tag recording information”) stored in a storage region (not illustrated) of each RF tag T.

Herein, at least identification information (tag ID) unique to an individual is stored in the storage region of the RF tag T. Information related to a product provided with the RF tag T may be further stored in the storage region of the RF tag T. Tag recording information (a tag ID, or information including a tag ID and product information) stored in the storage region of the RF tag T is transported by a radio wave emitted from the RF tag T. Further, the tag reading apparatus 220 measures intensity of a radio wave when the tag reading apparatus 220 reads tag recording information of the RF tag T provided to each product, and associates information indicating the intensity of the radio wave with the tag recording information transported by the radio wave.

Although not illustrated in FIG. 1, a plurality of the gates 20 may be provided side by side. When the plurality of gates 20 are provided side by side, a not-illustrated radio wave shield member (for example, an aluminum sheet, and the like) is preferably disposed outside the side wall portions 20A and 20B of each of the gates 20. For example, the following effect can be acquired by the radio wave shield member disposed outside the side wall portions 20A and 20B. In other words, an effect of reducing a possibility that, when a certain person passes through the gate 20, another adjacent gate 20 receives, by mistake, a radio wave of the RF tag T provided to a product to be purchased by the certain person can be acquired.

Note that, a configuration of the gate 20 is not limited to the example in FIG. 1. For example, the tag reading apparatus 220 may be incorporated as a part of the gate 20 into the gate 20, and may be provided as a single apparatus separated from the gate 20.

### Functional Configuration of Store Apparatus 10

As illustrated in FIG. 1, the store apparatus 10 according to the present example embodiment includes a reading result registration unit 110, a purchase product confirmation unit 120, a checkout unit 130, and an electronic receipt issuing unit 140.

The reading result registration unit 110 registers, for each person, a reading result (hereinafter, also expressed as a “tag reading result”) of the RF tag T at the gate 20. First, the reading result registration unit 110 acquires a tag reading result and person determination information from the gate 20. The person determination information is information for determining a person (customer) who passes through the gate 20. The person determination information is acquired by using various modules of the person determination information acquisition apparatus 210 as described above, and is transmitted to the store apparatus 10. The tag reading result includes tag recording information acquired by reading the RF tag T provided to an individual product by the tag reading apparatus 220, and information indicating intensity of a radio wave received from each RF tag T during reading of the tag recording information. Then, the reading result registration unit 110 registers, in a not-illustrated storage region, the tag reading result and the person determination information being acquired from the gate 20 in association with each other.

Herein, when a specific condition is satisfied, the reading result registration unit 110 performs correction processing of correcting a tag reading result, for each person, being registered by the reading result registration unit 110. Herein, the “specific condition” is a condition that tag recording information related to the same RF tag T is included in both of a tag reading result related to a first person and a tag reading result related to a second person who passes through the gate 20 after the first person. In the following description, the tag reading result related to the first person is also expressed as a “first tag reading result”, and the tag reading result related to the second person is also expressed as a “second tag reading result”. Further, in the following description, the same RF tag T is also expressed as the “same RF tag”. When a specific condition is satisfied, the reading result registration unit 110 performs processing of correcting either one of the first tag reading result and the second tag reading result, based on magnitude of intensity of a radio wave received from the same RF tag. A content (i.e., a purchase product of the first person) of the first tag reading result related to the first person is confirmed by performing the correction processing.

To give description with the example in FIG. 1, a person indicated by a reference sign P1 is equivalent to a “first person”, and a person indicated by a reference sign P2 is equivalent to a “second person”. When the first person P1 passes through the gate 20, the reading result registration unit 110 acquires a tag reading result (first tag reading result) related to the first person P1 and person determination information about the first person P1. Then, the reading result registration unit 110 registers the pieces of information in association with each other. Further, when the first person P1 passes through the gate 20, and the second person P2 then passes through the gate 20, the reading result registration unit 110 acquires a tag reading result (second tag reading result) related to the second person P2 and person determination information about the second person P2. Then, the reading result registration unit 110 registers the pieces of information in association with each other. Further, in response to acquisition of the second tag reading result, the reading result registration unit 110 verifies the first tag reading result with the second tag reading result, and determines whether tag recording information of the same RF tag is included in both of the first tag reading result and the second tag reading result. When the tag recording information of the same RF tag is included in both of the first tag reading result and the second tag reading result, the reading result registration unit 110 corrects either one of the first tag reading result and the second tag reading result. On the other hand, when the tag recording information of the same RF tag is not included in both of the first tag reading result and the second tag reading result, the reading result registration unit 110 does not correct both of the first tag reading result and the second tag reading result.

The purchase product confirmation unit 120 confirms a purchase product of each person, based on a tag reading result, for each person, being registered (corrected in some cases) by the processing described above.

The checkout unit 130 performs checkout processing of the purchase product confirmed by the purchase product confirmation unit 120. For example, the checkout unit 130 operates as follows. First, when the checkout unit 130 performs the checkout processing of a purchase product confirmed based on a tag reading result, the checkout unit 130 acquires person determination information associated with the tag reading result. Then, the checkout unit 130 performs the checkout processing of the purchase product by using information (such as information about a credit card and a debit account) about a payment method being previously associated with the acquired person determination information.

The electronic receipt issuing unit 140 issues an electronic receipt associated with the checkout processing performed by the checkout unit 130. For example, the electronic receipt issuing unit 140 generates electronic receipt data, based on a content of the checkout processing, and transmits the electronic receipt data to the terminal 30. In this case, the electronic receipt issuing unit 140 can transmit the electronic receipt data to the terminal 30 by using destination information of the terminal 30 previously associated with the person determination information. Further, the electronic receipt issuing unit 140 may be configured in such a way as to store, in a not-illustrated server apparatus and the like, the generated electronic receipt data in association with the person determination information acquired in the checkout processing. In this case, a customer can confirm an electronic receipt by accessing the not-illustrated server apparatus and downloading the electronic receipt data into the terminal 30.

### Hardware Configuration Example of Store Apparatus 10

The store apparatus 10 may be achieved by hardware (for example: a hard-wired electronic circuit, and the like) that achieves each functional component unit, and may be achieved by a combination of hardware and software (for example: a combination of an electronic circuit and a program that controls the electronic circuit, and the like). Hereinafter, a case where the store apparatus 10 is achieved by the combination of hardware and software will be further described.

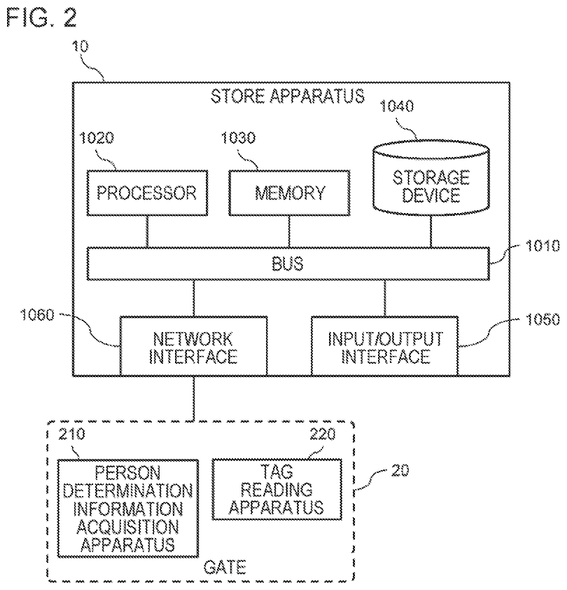

FIG. 2 is a block diagram illustrating a hardware configuration of the store apparatus 10.

The store apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (such as the reading result registration unit 110, the purchase product confirmation unit 120, the checkout unit 130, and the electronic receipt issuing unit 140) of the store apparatus 10. The processor 1020 reads each program module onto the memory 1030 and executes each program module, and each function associated with each program module is achieved.

The input/output interface 1050 is an interface for connecting the store apparatus 10 to a not-illustrated peripheral apparatus. The peripheral apparatus includes, for example, an input apparatus such as a keyboard and a mouse, and an output apparatus such as a display (touch panel display) and a speaker. Note that, an input apparatus and an output apparatus as described above may not be connected to the input/output interface 1050.

The network interface 1060 is an interface for connecting the store apparatus 10 to a network. The network is, for example, a local area network (LAN) and a wide area network (WAN). A method of connection to the network by the network interface 1060 may be wireless connection or wired connection. The store apparatus 10 is communicably connected to an external apparatus such as the person determination information acquisition apparatus 210 and the tag reading apparatus 220 of the gate 20 via the network interface 1060.

Note that, the configuration illustrated in FIG. 2 is merely one example, and a configuration of hardware including the store apparatus 10 is not limited to the example in FIG. 2.

### Flow of Processing

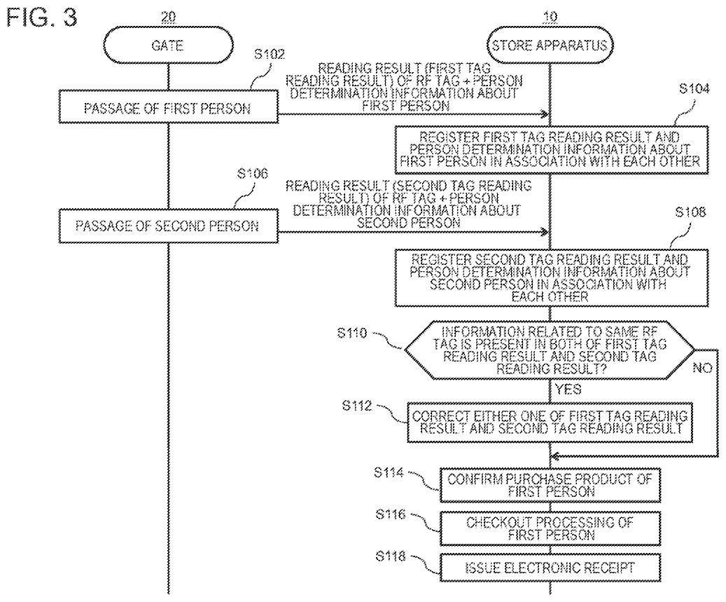

By using FIG. 3, a flow of processing performed by the store system 1 according to the present example embodiment will be described. FIG. 3 is a sequence diagram illustrating the flow of the processing performed by the store system 1 according to the first example embodiment.

First, when a first person passes through the gate 20 (S102), person determination information about the first person is acquired by the person determination information acquisition apparatus 210. Further, an RF tag of a product to be purchased by the first person is read by the tag reading apparatus 220, and a tag reading result (first tag reading result) related to the first person is acquired. The first tag reading result and the person determination information about the first person being acquired at the gate 20 are transmitted to the store apparatus 10. The reading result registration unit 110 registers, in a storage region such as the storage device 1040, the first tag reading result and the person determination information about the first person being acquired from the gate 20 in association with each other (S104).

When the first person passes through the gate 20, and a second person then passes through the gate 20 (S106), person determination information about the second person is acquired by the person determination information acquisition apparatus 210. Further, an RF tag of a product to be purchased by the second person is read by the tag reading apparatus 220, and a tag reading result (second tag reading result) related to the second person is acquired. The second tag reading result and the person determination information about the second person being acquired at the gate 20 are transmitted to the store apparatus 10. The reading result registration unit 110 registers, in the storage region such as the storage device 1040, the second tag reading result and the person determination information about the second person being acquired from the gate 20 in association with each other (S108).

When the second tag reading result is acquired by the store apparatus 10, the reading result registration unit 110 verifies the first tag reading result with the second tag reading result, and determines whether tag recording information of the same RF tag is present in both of the first tag reading result and the second tag reading result (S110). When the tag recording information of the same RF tag is present in both of the first tag reading result and the second tag reading result (S110: YES), the reading result registration unit 110 corrects either one of the first tag reading result and the second tag reading result (S112). On the other hand, when the tag recording information of the same RF tag is not present in both of the first tag reading result and the second tag reading result (S110: NO), the reading result registration unit 110 does not correct both of the first tag reading result and the second tag reading result. When either one of the first tag reading result and the second tag reading result is corrected in the processing in S112, or when it turns out that the tag recording information of the same RF tag is not present in the processing in S110, the first tag reading result is confirmed. Then, the purchase product confirmation unit 120 determines a purchase product of the first person, based on the confirmed first tag reading result (S114).

Then, the checkout unit 130 performs checkout processing (payment processing of a product price) by using information about the purchase product of the first person being confirmed in the processing in S114 (S116). Then, the electronic receipt issuing unit 140 issues electronic receipt data associated with the checkout processing (S118). For example, the electronic receipt issuing unit 140 transmits, to a terminal possessed by the first person, data about an electronic receipt generated based on a result of the checkout processing. Further, the electronic receipt issuing unit 140 may transmit, to a not-illustrated server apparatus, data about an electronic receipt generated based on a result of the checkout processing, in association with the person determination information about the first person. In the latter case, for example, the person determination information about the first person is transmitted to the server apparatus via an application installed in the terminal, and the like, and thus electronic receipt data associated with the person determination information are transmitted from the server apparatus to the terminal.

### Specific Example of Processing

Hereinafter, processing performed by the store apparatus 10 according to the present example embodiment will be described with a specific example.

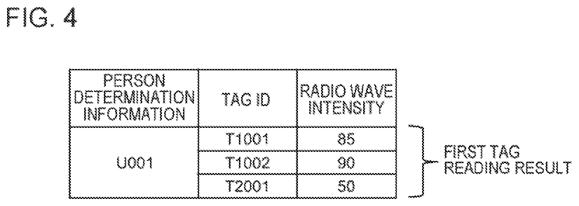

First, by the first person passing through the gate 20, information related to the first person is registered in a predetermined storage region such as the memory 1030 and the storage device 1040 (for example: FIG. 4). FIG. 4 is a diagram illustrating a state in the storage region after the first person passes through the gate 20. According to FIG. 4, it is clear that the tag reading apparatus 220 of the gate 20 reads three tags (i.e., three products) individually identified by a tag ID “T1001”, a tag ID “T1002”, and a tag ID “T2001” during passage of the first person. Further, it is clear that the tag reading apparatus 220 of the gate 20 receives each radio wave having intensity of “85”, intensity of “90”, and intensity of “50” from the tag ID “T1001”, the tag ID “T1002”, and the tag ID “T2001”, respectively.

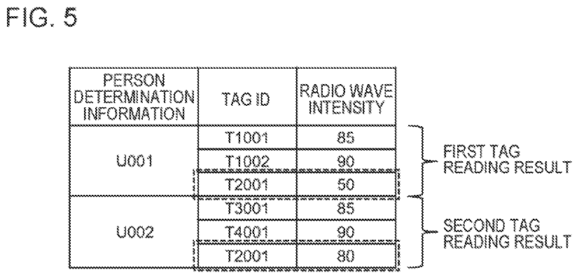

Next, by the second person passing through the gate 20, information related to the second person is further registered in the predetermined storage region such as the memory 1030 and the storage device 1040 (for example: FIG. 5). FIG. 5 is a diagram illustrating a state in the storage region after the second person passes through the gate 20. According to FIG. 5, it is clear that the tag reading apparatus 220 of the gate 20 reads three tags (i.e., three products) individually identified by a tag ID “T3001”, a tag ID “T4001”, and a tag ID “T2001” during passage of the second person. Further, it is clear that the tag reading apparatus 220 of the gate 20 receives each radio wave having intensity of “85”, intensity of “90”, and intensity of “80” from the tag ID “T3001”, the tag ID “T4001”, and the tag ID “T2001”, respectively.

Herein, as indicated by a dotted line in FIG. 5, tag recording information (tag ID “T2001”) of the same RF tag is included in both of a tag reading result (first tag reading result) related to the first person and a tag reading result (second tag reading result) related to the second person. In other words, in the example in FIG. 5, the “specific condition” described above is satisfied. When the tag recording information of the same RF tag is included in both of the first tag reading result and the second tag reading result as illustrated in FIG. 5, the reading result registration unit 110 corrects either one of the first tag reading result and the second tag reading result, based on the intensity of the radio wave received from the same RF tag.

Specifically, the reading result registration unit 110 operates as follows. First, the reading result registration unit 110 compares the radio wave intensity of the same RF tag included in the first tag reading result with the radio wave intensity of the same RF tag included in the second tag reading result, and determines a tag reading result having smaller radio wave intensity. Then, the reading result registration unit 110 physically or logically deletes tag recording information related to the same RF tag being included in the tag reading result determined to have smaller radio wave intensity.

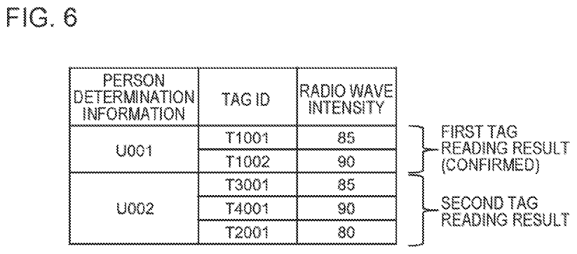

In the example in FIG. 5, since the radio wave intensity included in the first tag reading result is smaller, the reading result registration unit 110 deletes the information of the tag ID “T2001” included in the first tag reading result. As a result, information stored in the predetermined storage region becomes in a state as illustrated in FIG. 6, for example. FIG. 6 is a diagram illustrating the state in the storage region after the first tag reading result is corrected. In this case, the first tag reading result is confirmed in the state in FIG. 6.

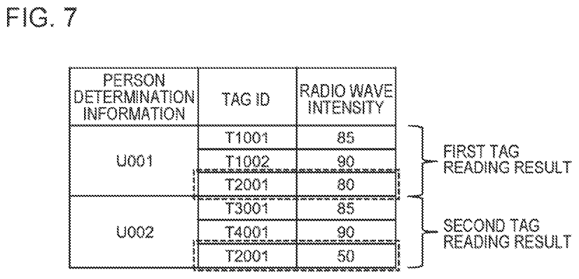

Herein, it is assumed that, as a result of passage of the first person and the second person through the gate 20, a state in the predetermined storage region is a state as illustrated in FIG. 7. FIG. 7 is a diagram illustrating the state in the storage region after the second person passes through the gate 20. In the example in FIG. 7, as indicated by a dotted line, the tag recording information (tag ID “T2001”) of the same RF tag T is included in both of the tag reading result (first tag reading result) related to the first person and the tag reading result (second tag reading result) related to the second person. In other words, in the example in FIG. 7, the “specific condition” described above is satisfied.

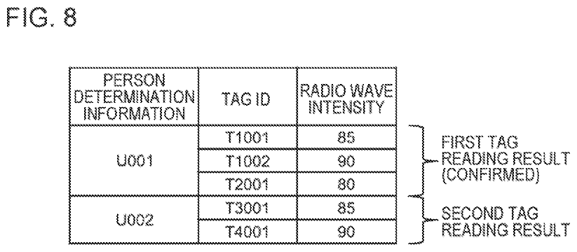

In the example in FIG. 7, since the radio wave intensity included in the second tag reading result is smaller, the reading result registration unit 110 deletes the information of the tag ID “T2001” included in the second tag reading result. As a result, information stored in the predetermined storage region becomes in a state as illustrated in FIG. 8, for example. FIG. 8 is a diagram illustrating the state in the storage region after the second tag reading result is corrected. In this case, the first tag reading result is confirmed in the state in FIG. 8.

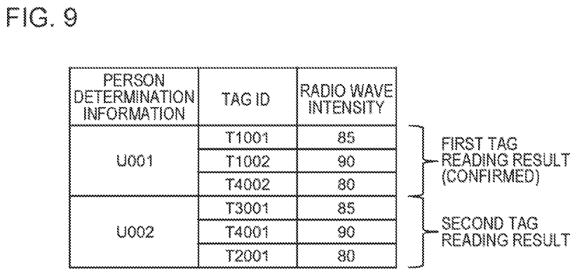

Further, it is assumed that, as a result of passage of the first person and the second person through the gate 20, a state in the predetermined storage region is a state as illustrated in FIG. 9. FIG. 9 is a diagram illustrating the state in the storage region after the second person passes through the gate 20. In the example in FIG. 9, tag recording information included in a first tag reading result is “T1001”, “T1002”, and “T4002”, and tag recording information included in a second tag reading result is “T3001”, “T4001”, and “T2001”. In other words, in the example in FIG. 9, the “specific condition” described above is not satisfied. Thus, in the example in FIG. 9, the reading result registration unit 110 does not correct both of the first tag reading result and the second tag reading result. In this case, the first tag reading result is confirmed in the state in FIG. 9.

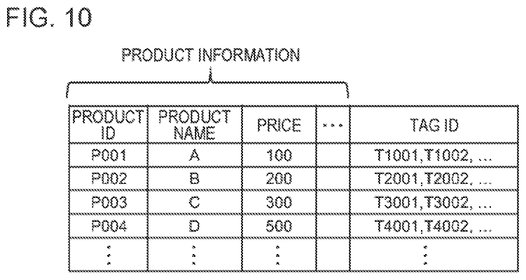

The purchase product confirmation unit 120 confirms a purchase product of the first person, based on the confirmed first tag reading result. For example, the purchase product confirmation unit 120 can determine a purchase product of the first person from the first tag reading result by using information indicating a correspondence between an RF tag and a product as illustrated in FIG. 10. FIG. 10 is one example of information that defines a correspondence between each product and an RF tag. In the information illustrated in FIG. 10, identification information (tag ID) of each RF tag is associated with product information about a product provided with the RF tag. For example, when the first tag reading result is confirmed in the state in FIG. 6, the purchase product confirmation unit 120 can determine a purchase product of the first person as “two products A” by using the information illustrated in FIG. 10. Further, for example, when the first tag reading result is confirmed in the state in FIG. 8, the purchase product confirmation unit 120 can determine a purchase product of the first person as “two products A and one product B” by using the information illustrated in FIG. 10. Further, for example, when the first tag reading result is confirmed in the state in FIG. 9, the purchase product confirmation unit 120 can determine a purchase product of the first person as “two products A and one product D” by using the information illustrated in FIG. 10. Then, the store apparatus 10 performs checkout processing, based on a result of confirming the purchase product of the first person. Note that, when information about a product used for the checkout processing is stored in each RF tag, the product information is included in a tag reading result of the person. In this case, after a tag reading result (i.e., a purchase product of the first person) related to the first person is confirmed, the checkout unit 130 can perform the checkout processing by using product information included in the tag reading result. Then, the electronic receipt issuing unit 140 issues an electronic receipt, based on a content of the checkout processing.

As described above, the present example embodiment can prevent occurrence of false recognition of a product caused by reading, by mistake, an RF tag provided to a purchase product of a different person present near the gate 20 that recognizes a product, based on an RF tag provided to an individual product, when a certain person passes through the gate 20. In this way, the store system 1 including the gate 20 can accurately perform checkout processing of each person.

### Second Example Embodiment

Intensity of a radio wave received by a tag reading apparatus 220 of a gate 20 fluctuates depending on a positional relationship between the tag reading apparatus 220 and an RF tag (relative orientation and distance between the tag reading apparatus 220 and an RF tag). For example, when an RF tag is located outside the gate 20 (such as a waiting place in front of the gate 20), intensity of a radio wave from the RF tag being received by the tag reading apparatus 220 is attenuated further than that when the RF tag is located inside the gate 20. In other words, by using intensity of a radio wave received from each RF tag, whether the RF tag read by the tag reading apparatus 220 at a certain point of time is provided to a product to be purchased by a person different from a person who passes through the gate 20 at the point of time can be estimated.

### Functional Configuration

Thus, a reading result registration unit 110 according to the present example embodiment is configured to perform correction processing as described above when a radio wave having intensity less than a predetermined threshold value is included in a first tag reading result. In other words, the reading result registration unit 110 according to the present example embodiment does not perform the correction processing as described above in a case where a radio wave having intensity equal to or greater than a reference (predetermined threshold value) can be received for all RF tags read by the tag reading apparatus 220 when a first person passes through the gate 20. In a case where a radio wave having intensity of magnitude equal to or greater than the reference can be received from all RF tags (i.e., a case where a radio wave having intensity less than the predetermined threshold value is not included in the first tag reading result) when the first person passes through the gate 20, it can be estimated that a possibility that the tag reading apparatus 220 receives a radio wave of an RF tag provided to a purchase product of a second person is low. In this case, the reading result registration unit 110 confirms the first tag reading result without waiting for a tag reading result related to the second person to be acquired. Then, a purchase product confirmation unit 120 confirms a purchase product of the first person, based on the first tag reading result, and a checkout unit 130 performs checkout processing for the purchase product of the first person. Note that, a store apparatus 10 according to the present example embodiment has a configuration (configuration illustrated in FIG. 1) similar to that in the first example embodiment except for the point described above.

Note that, the “predetermined threshold value” described above can be determined based on a result of experimentally measuring radio wave intensity in a state where an RF tag is located inside the gate 20 or radio wave intensity in a state where an RF tag is located outside the gate 20, for example. For example, it is assumed that a statistic (such as an average value and a median) based on the result of experimentally measuring the radio wave intensity in the former state is “80”, and a statistic (such as an average value and a median) based on the result of experimentally measuring the radio wave intensity in the latter state is “50”. In this case, any value between “50” and “80” may be set as a threshold value for determining whether the correction processing is performed. For example, a value (specifically, “65”) located midway between the two statistics is set as a threshold value for determining whether the correction processing is performed.

### Flow of Processing

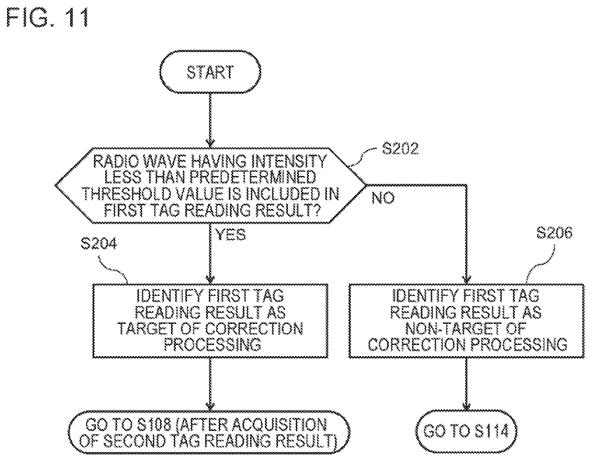

By using FIG. 11, a flow of processing according to the present example embodiment will be described. FIG. 11 is a flowchart illustrating a flow of processing performed by the store apparatus 10 according to a second example embodiment. The processing illustrated in FIG. 11 is performed after the processing in S104 in FIG. 3.

First, the reading result registration unit 110 refers to information related to intensity of a radio wave received from each RF tag included in a first tag reading result, and determines whether a radio wave having intensity less than a predetermined threshold value is received when a first person passes through the gate 20 (S202). Herein, the predetermined threshold value is previously stored in a storage region that can be accessed by the reading result registration unit 110, such as a memory 1030, for example.

In a case where the radio wave having intensity less than the predetermined threshold value is received when the first person passes through the gate 20 (S202: YES), the reading result registration unit 110 identifies the first tag reading result as a target of the correction processing (S204). For example, the reading result registration unit 110 sets, as “1 (value indicating a processing target)”, information (target identification flag) for identifying whether the first tag reading result is a target of the correction processing. When the target identification flag is set as “1”, the reading result registration unit 110 performs the correction processing as described in the first example embodiment in response to a second tag reading result being acquired by passage of a second person through the gate 20 (S106 in FIG. 3). Specifically, the reading result registration unit 110 performs processing of verifying the first tag reading result with the second tag reading result (S110 in FIG. 3). Then, when tag recording information of a same RF tag is included in both of the first tag reading result and the second tag reading result, the reading result registration unit 110 corrects either one of the first tag reading result and the second tag reading result (S112 in FIG. 3) as described in the first example embodiment.

On the other hand, when the radio wave having intensity less than the predetermined threshold value is not received when the first person passes through the gate 20 (S202: NO), the reading result registration unit 110 identifies the first tag reading result as a non-target of the correction processing (S206). For example, the reading result registration unit 110 sets, as “0 (value indicating a non-processing target)”, the target identification flag described above. When the target identification flag of the first tag reading result is set as “0”, the reading result registration unit 110 confirms a content of the first tag reading result.

Note that, in the processing in FIG. 11, the first tag reading result is confirmed in a stage in which the first tag reading result is identified as a non-target of the correction processing. Thus, the purchase product confirmation unit 120 can confirm a purchase product of the first person, based on the first tag reading result, without waiting for acquisition of the second tag reading result (S114 in FIG. 3).

As described above, in the configuration according to the present example embodiment, when it can be estimated that the tag reading apparatus 220 does not receive a radio wave of an RF tag provided to a purchase product of the second person, a purchase product of the first person is confirmed at the point of time. In this way, checkout processing of the first person can be smoothly completed.

### Modification Example

When radio wave intensity of at least one RF tag is less than the predetermined threshold value in the first tag reading result, there is a possibility that the RF tag is provided to a purchase product of the second person (i.e., the RF tag corresponds to the same RF tag). Thus, the first tag reading result cannot be confirmed until the second person passes through the gate 20 and the second tag reading result is acquired. Herein, when radio wave intensity of all RF tags is equal to or greater than the predetermined threshold value in the second tag reading result, the reading result registration unit 110 can confirm the first tag reading result (purchase product of the first person) together with the second tag reading result (purchase product of the second person). When an RF tag having radio wave intensity less than the predetermined threshold value in the first tag reading result corresponds to the same RF tag, it is confirmed that the radio wave intensity of the same RF tag in the second tag reading result is greater than the radio wave intensity of the same RF tag in the first tag reading result. Thus, in this case, the reading result registration unit 110 can confirm the second tag reading result as it is, and also confirm the first tag reading result by performing the correction processing on the first tag reading result. Further, when an RF tag having radio wave intensity less than the predetermined threshold value in the first tag reading result does not correspond to the same RF tag, it is confirmed that the RF tag is not provided to a purchase product of the second person. Thus, in this case, the reading result registration unit 110 can confirm the first tag reading result and the second tag reading result without performing the correction processing.

### Third Example Embodiment

In a case where there is no other person near a gate 20 when a certain person passes through the gate 20, a possibility that the gate 20 reads, by mistake, an RF tag of a product to be purchased by the other person is reduced. Thus, a store apparatus 10 according to the present example embodiment further has a configuration that determines whether there is another person near the gate 20, confirms a tag reading result of a first person according to the result, and performs checkout processing. The store apparatus 10 according to the present example embodiment has a configuration (configuration illustrated in FIG. 1) similar to that in the first example embodiment except for a point described below.

### First Functional Configuration Example

As one example, a reading result registration unit 110 may be configured to determine whether a second person is present near the gate 20 when a first person passes through the gate 20 from a difference between time at which the first person passes through the gate 20 and time at which the second person passes through the gate 20. For example, the reading result registration unit 110 confirms a first tag reading result when a predetermined period of time has elapsed since the first person passes through the gate 20 without the second person passing through the gate 20. Note that, the “predetermined period of time” can be set as any value (for example, a few minutes to ten and a few minutes, and the like). Then, a purchase product confirmation unit 120 confirms a purchase product of the first person, based on the first tag reading result, and a checkout unit 130 performs checkout processing for the purchase product of the first person.

### Flow of Processing

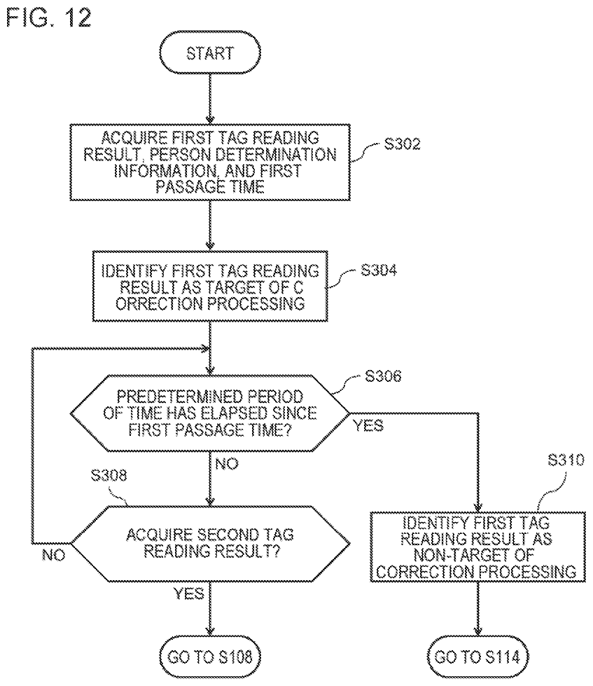

By using FIG. 12, a flow of processing according to the present example embodiment will be described. FIG. 12 is a flowchart illustrating a flow of processing performed by the store apparatus 10 according to a third example embodiment.

First, the reading result registration unit 110 acquires, from the gate 20, time (hereinafter, also expressed as “first passage time”) at which a first person passes through the gate 20 in addition to a reading result (first tag reading result) of an RF tag related to the first person and person determination information about the first person, and registers the first passage time, the first tag reading result, and the person determination information in a predetermined storage region (S302).

Herein, time at which a certain person passes through the gate 20 may be time at which the person enters the gate 20, and may be time at which the person exits from the gate 20. Time at which a certain person enters the gate 20 can be acquired by using a entering person detection sensor (not illustrated) provided near an entrance of the gate 20, for example. Similarly, time at which a certain person exits from the gate 20 can be acquired by using an exiting person detection sensor (not illustrated) provided near an exit of the gate 20, for example. Further, time at which a certain person passes through the gate 20 may be time at which a product is read at the gate 20 (a tag reading apparatus 220 operates). In addition, time at which a certain person passes through the gate 20 may be time at which the gate 20 transmits a reading result of an RF tag and person determination information to the store apparatus 10, or may be time at which the store apparatus 10 receives a reading result of an RF tag and person determination information from the gate 20.

The reading result registration unit 110 uniformly identifies the first tag reading result acquired in the processing in S302 as a target of correction processing (S304). For example, the reading result registration unit 110 sets, as “1 (value indicating a processing target)”, information (target identification flag) for identifying whether the first tag reading result is a target of the correction processing. When the target identification flag is set as “1”, the processing (S108 to S118 in FIG. 3) including the correction processing as described in the first example embodiment is performed in response to a second tag reading result being acquired by passage of a second person through the gate 20.

Then, the reading result registration unit 110 determines whether a predetermined period of time has elapsed since the first person passes through the gate 20 (S306). For example, the reading result registration unit 110 determines whether a difference between system time of the store apparatus 10 and the like and the first passage time acquired in S302 exceeds the predetermined period of time. Herein, information related to the predetermined period of time is previously stored in a storage region that can be accessed by the reading result registration unit 110, such as a memory 1030, for example.

When the predetermined period of time has not elapsed since the first person passes through the gate 20 (S306: NO), the reading result registration unit 110 further determines whether a tag reading result related to the second person is acquired (S308). When the tag reading result related to the second person is not yet acquired (S308: NO), the reading result registration unit 110 waits for the second tag reading result to be acquired until the predetermined period of time has elapsed since the first person passes through the gate 20 (S306: YES). Then, when the tag reading result related to the second person is acquired before the predetermined period of time has elapsed since the first person passes through the gate 20 (S308: YES), the processing transitions to S108 in FIG. 3.

On the other hand, when the predetermined period of time has elapsed without the tag reading result related to the second person being acquired (S306: YES), the reading result registration unit 110 identifies the first tag reading result as a non-target of the correction processing (S310). For example, the reading result registration unit 110 sets, as “0 (value indicating a non-processing target)”, the target identification flag described above. In a case where the target identification flag is set as “0”, the reading result registration unit 110 does not perform the correction processing (S112 in FIG. 3) even when the second person passes through the gate 20 and the second tag reading result is acquired.

Note that, in the processing in FIG. 12, the first tag reading result is confirmed in a stage in which the first tag reading result is identified as a non-target of the correction processing. Thus, the purchase product confirmation unit 120 can confirm a purchase product of the first person, based on the first tag reading result, without waiting for acquisition of the second tag reading result (S114 in FIG. 3). Then, the checkout unit 130 performs checkout processing for the purchase product of the first person (S116 in FIG. 3), and an electronic receipt issuing unit 140 issues an electronic receipt, based on the checkout processing (S118 in FIG. 3).

As described above, according to the present example embodiment, in a case where it can be estimated that there is no second person near the gate 20 when the first person passes through the gate 20, in other words, in a case where it can be estimated that the tag reading apparatus 220 does not receive a radio wave of an RF tag provided to a purchase product of the second person, a purchase product of the first person is confirmed at the point of time, and checkout processing is performed based on information about the confirmed purchase product (S114 and S116 in FIG. 3). According to the configuration of the present example embodiment, the checkout processing of the first person can be smoothly completed.

### Modification Example

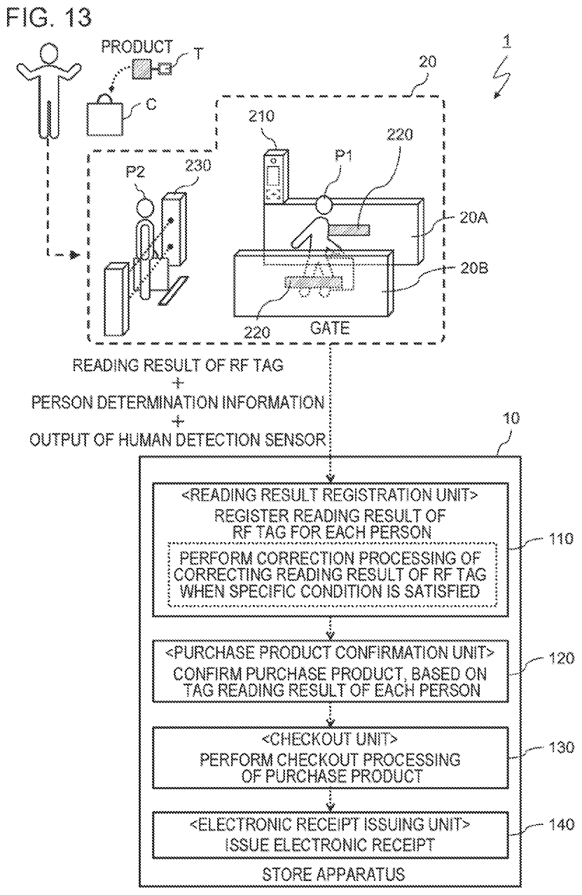

As a modification example of the present example embodiment, a human detection sensor may be provided near an entrance side of the gate 20, and whether the second person is present near the gate 20 when the first person passes through the gate 20 may be able to be determined (for example: FIG. 13).

FIG. 13 is a diagram illustrating a configuration of a store system 1 according to the modification example of the third example embodiment. As illustrated, in the store system 1 according to the present modification example, the gate 20 includes a human detection sensor 230 near the gate 20 (for example: near a waiting place of the gate 20). In the present modification example, the store apparatus 10 acquires an output result of the human detection sensor 230 in addition to a reading result of an RF tag and person determination information. Herein, the human detection sensor 230 is, for example, a sensor using infrared rays. Further, the human detection sensor 230 may be a capturing apparatus including a camera module. In this case, the human detection sensor 230 outputs, to the store apparatus 10, as information that can determine whether there is the second person, an image generated by the camera module or a feature value that can be extracted from the image. The store apparatus 10 can acquire an output of the human detection sensor 230 via the network interface 1060 in FIG. 2, for example.

The reading result registration unit 110 according to the present modification example omits correction processing when another person (second person) is not detected by the human detection sensor 230 while the first person passes through the gate 20. In other words, when another person (second person) is not detected by the human detection sensor provided near an entrance side of the gate 20 while the first person passes through the gate 20, the reading result registration unit 110 confirms a tag reading result related to the first person. Note that, the reading result registration unit 110 can determine whether the first person passes through the gate 20, based on an output of a different sensor provided inside the gate 20 or a state of a reading operation of the tag reading apparatus 220. Then, the purchase product confirmation unit 120 confirms a purchase product of the first person, based on the first tag reading result, and the checkout unit 130 performs checkout processing for the purchase product of the first person.

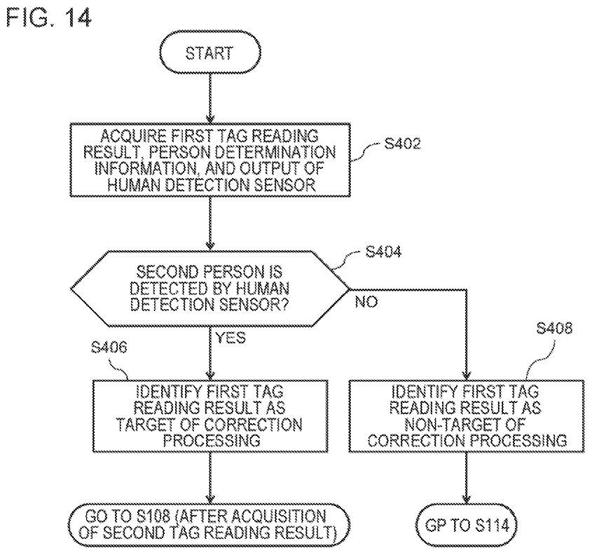

FIG. 14 is a flowchart illustrating a flow of processing performed in the modification example of the third example embodiment.

First, the reading result registration unit 110 acquires, from the gate 20, an output of the human detection sensor 230 together with a reading result (first tag reading result) of an RF tag related to a first person and person determination information about the first person (S402).

Then, the reading result registration unit 110 determines whether a second person is detected by the human detection sensor 230, based on the output of the human detection sensor 230 acquired in the processing in S402 (S404).

When the second person is detected by the human detection sensor 230 (S404: YES), the reading result registration unit 110 identifies the first tag reading result acquired in the processing in S402 as a target of correction processing (S406). For example, the reading result registration unit 110 sets, as “1 (value indicating a processing target)”, information (target identification flag) for identifying whether the first tag reading result is a target of the correction processing. When the target identification flag is set as “1”, the processing (S108 to 5118 in FIG. 3) including the correction processing as described in the first example embodiment is performed in response to a second tag reading result being acquired by passage of the second person through the gate 20.

On the other hand, when the second person is not detected by the human detection sensor 230 (S404: NO), the reading result registration unit 110 identifies the first tag reading result acquired in the processing in 5402 as a non-target of the correction processing (S408). For example, the reading result registration unit 110 sets, as “0 (value indicating a non-processing target)”, the target identification flag described above. In a case where the target identification flag is set as “0”, the reading result registration unit 110 does not perform the correction processing (S112 in FIG. 3) even when the second person passes through the gate 20 and the second tag reading result is acquired.

Note that, in the processing in FIG. 14, the first tag reading result is confirmed in a stage in which the first tag reading result is identified as a non-target of the correction processing. Thus, the purchase product confirmation unit 120 can confirm a purchase product of the first person, based on the first tag reading result, without waiting for acquisition of the second tag reading result (S114 in FIG. 3). Then, the checkout unit 130 performs checkout processing for the purchase product of the first person (S116 in FIG. 3), and an electronic receipt issuing unit 140 issues an electronic receipt, based on the checkout processing (S118 in FIG. 3).

As described above, the present modification example can also acquire the effect of the third example embodiment described above.

While the example embodiments of the present invention have been described above with reference to the drawings, the present invention should not be limited to the example embodiments for interpretation. Various modifications, improvements, and the like can be made based on knowledge of a person skilled in the art without departing from the scope of the present invention. A plurality of components disclosed in the example embodiments can form various inventions by an appropriate combination. For example, some components may be deleted from all the components indicated in the example embodiments, and components in different example embodiments may be appropriately combined.

Further, the plurality of steps (processing) are described in an order in the sequence diagram and the plurality of flowcharts used in the above-described description, but an execution order of steps performed in each of the example embodiments is not limited to the described order. In each of the example embodiments, an order of illustrated steps may be changed within an extent that there is not harm in context. Further, each of the example embodiments described above can be combined within an extent that a content is not inconsistent.

A part or the whole of the above-described example embodiment may also be described in supplementary notes below, which is not limited thereto.
1. A store apparatus, including:

a reading result registration unit that registers a tag reading result including tag recording information acquired by reading a tag provided to an individual product by a reading apparatus provided at a gate and intensity of a radio wave received from the tag, in association with person determination information that determines a person who passes through the gate;

a purchase product confirmation unit that confirms a purchase product, based on the tag reading result for each person;

a checkout unit that performs checkout processing of the confirmed purchase product; and

an electronic receipt issuing unit that issues an electronic receipt for the checkout processing, wherein,

when tag recording information related to a same tag is included in both of a first tag reading result related to a first person and a second tag reading result related to a second person who passes through the gate after the first person, the reading result registration unit confirms the first tag reading result, based on magnitude of intensity of a radio wave received from the same tag.
2. The store apparatus according to supplementary note 1, wherein

the reading result registration unit performs correction processing of correcting either one of the first tag reading result and the second tag reading result, based on magnitude of intensity of a radio wave received from the same tag.
3. The store apparatus according to supplementary note 2, wherein

the reading result registration unit deletes tag recording information related to the same tag being included in a tag reading result having smaller intensity of a radio wave received from the same tag between the first tag reading result and the second tag reading result.
4. The store apparatus according to supplementary note 2 or 3, wherein

the reading result registration unit performs the correction processing when a radio wave having intensity less than a predetermined threshold value is included in the first tag reading result.
5. The store apparatus according to any one of supplementary notes 1 to 4, wherein,

when a radio wave having intensity less than a predetermined threshold value is not included in the first tag reading result,
the reading result registration unit confirms the first tag reading result,
the purchase product confirmation unit confirms a purchase product of the first person, based on the first tag reading result, and
the checkout unit performs checkout processing of the purchase product of the first person.
6. The store apparatus according to any one of supplementary notes 1 to 5, wherein,

when a predetermined period of time has elapsed without the second person passing through the gate after the first person passes through the gate,
the reading result registration unit confirms the first tag reading result,
the purchase product confirmation unit confirms a purchase product of the first person, based on the first tag reading result, and
the checkout unit performs checkout processing of the purchase product of the first person.
7. The store apparatus according to any one of supplementary notes 1 to 5, wherein

the gate includes a human detection sensor on an entrance side, and,

when the second person is not detected by the human detection sensor while the first person passes through the gate,
the reading result registration unit confirms the first tag reading result,
the purchase product confirmation unit confirms a purchase product of the first person, based on the first tag reading result, and
the checkout unit performs checkout processing of the purchase product of the first person.
8. A store system, including:

a gate including a reading apparatus that reads a tag provided to an individual product;

a reading result registration unit that registers a tag reading result including tag recording information acquired by reading a tag provided to an individual product by the reading apparatus provided at the gate and intensity of a radio wave received from the tag, in association with person determination information that determines a person who passes through the gate;

a purchase product confirmation unit that confirms a purchase product, based on the tag reading result for each person;

a checkout unit that performs checkout processing of the confirmed purchase product; and

an electronic receipt issuing unit that issues an electronic receipt for the checkout processing, wherein,

when tag recording information related to a same tag is included in both of a first tag reading result related to a first person and a second tag reading result related to a second person who passes through the gate after the first person, the reading result registration unit confirms the first tag reading result, based on magnitude of intensity of a radio wave received from the same tag.
9. The store system according to supplementary note 8, wherein

the reading result registration unit performs correction processing of correcting either one of the first tag reading result and the second tag reading result, based on magnitude of intensity of a radio wave received from the same tag.
10. The store system according to supplementary note 9, wherein

the reading result registration unit deletes tag recording information related to the same tag being included in a tag reading result having smaller intensity of a radio wave received from the same tag between the first tag reading result and the second tag reading result.
11. The store system according to supplementary note 9 or 10, wherein

the reading result registration unit performs the correction processing when a radio wave having intensity less than a predetermined threshold value is included in the first tag reading result.
12. The store system according to any one of supplementary notes 8 to 11, wherein,

when a radio wave having intensity less than a predetermined threshold value is not included in the first tag reading result,
the reading result registration unit confirms the first tag reading result,
the purchase product confirmation unit confirms a purchase product of the first person, based on the first tag reading result, and
the checkout unit performs checkout processing of the purchase product of the first person.
13. The store system according to any one of supplementary notes 8 to 12, wherein,

when a predetermined period of time has elapsed without the second person passing through the gate after the first person passes through the gate,
the reading result registration unit confirms the first tag reading result,
the purchase product confirmation unit confirms a purchase product of the first person, based on the first tag reading result, and
the checkout unit performs checkout processing of the purchase product of the first person.
14. The store system according to any one of supplementary notes 8 to 12, wherein

the gate includes a human detection sensor on an entrance side, and,

when the second person is not detected by the human detection sensor while the first person passes through the gate,
the reading result registration unit confirms the first tag reading result,
the purchase product confirmation unit confirms a purchase product of the first person, based on the first tag reading result, and
the checkout unit performs checkout processing of the purchase product of the first person.
15. A checkout method executed by a computer, including:

registering a tag reading result including tag recording information acquired by reading a tag provided to an individual product by a reading apparatus provided at a gate and intensity of a radio wave received from the tag, in association with person determination information that determines a person who passes through the gate;

confirming, when tag recording information related to a same tag is included in both of a first tag reading result related to a first person and a second tag reading result related to a second person who passes through the gate after the first person, the first tag reading result, based on magnitude of intensity of a radio wave received from the same tag;

confirming a purchase product, based on the tag reading result for each person;

performing checkout processing of the confirmed purchase product; and

issuing an electronic receipt for the checkout processing.
16. The checkout method according to supplementary note 15, further including,

performing correction processing of correcting either one of the first tag reading result and the second tag reading result, based on magnitude of intensity of a radio wave received from the same tag.
17. The checkout method according to supplementary note 16, further including,

deleting tag recording information related to the same tag being included in a tag reading result having smaller intensity of a radio wave received from the same tag between the first tag reading result and the second tag reading result.
18. The checkout method according to supplementary note 16 or 17, further including,

performing the correction processing when a radio wave having intensity less than a predetermined threshold value is included in the first tag reading result.
19. The checkout method according to any one of supplementary notes 15 to 18, further including:

when a radio wave having intensity less than a predetermined threshold value is not included in the first tag reading result,
confirming the first tag reading result;
confirming a purchase product of the first person, based on the first tag reading result; and
performing checkout processing of the purchase product of the first person.
20. The checkout method according to any one of supplementary notes 15 to 19, further including:

when a predetermined period of time has elapsed without the second person passing through the gate after the first person passes through the gate,
confirming the first tag reading result;
confirming a purchase product of the first person, based on the first tag reading result; and
performing checkout processing of the purchase product of the first person.
21. The checkout method according to any one of supplementary notes 15 to 19,

wherein the gate including a human detection sensor on an entrance side,

the method further includes:

when the second person is not detected by the human detection sensor while the first person passes through the gate,
confirming the first tag reading result;
confirming a purchase product of the first person, based on the first tag reading result; and
performing checkout processing of the purchase product of the first person.
22. A program causing a computer to function as:

a unit that registers a tag reading result including tag recording information acquired by reading a tag provided to an individual product by a reading apparatus provided at a gate and intensity of a radio wave received from the tag, in association with person determination information that determines a person who passes through the gate;

a unit that confirms, when tag recording information related to a same tag is included in both of a first tag reading result related to a first person and a second tag reading result related to a second person who passes through the gate after the first person, the first tag reading result, based on magnitude of intensity of a radio wave received from the same tag;

a unit that confirms a purchase product, based on the tag reading result for each person;

a unit that performs checkout processing of the confirmed purchase product; and

a unit that issues an electronic receipt for the checkout processing.
23. The program according to supplementary note 22, further causing the computer to function as

a unit that performs correction processing of correcting either one of the first tag reading result and the second tag reading result, based on magnitude of intensity of a radio wave received from the same tag.
24. The program according to supplementary note 23, further causing the computer to function as

a unit that deletes tag recording information related to the same tag being included in a tag reading result having smaller intensity of a radio wave received from the same tag between the first tag reading result and the second tag reading result.
25. The program according to supplementary note 23 or 24, further causing the computer to function as

a unit that performs the correction processing when a radio wave having intensity less than a predetermined threshold value is included in the first tag reading result.
26. The program according to any one of supplementary notes 22 to 25, further causing the computer to function as,

when a radio wave having intensity less than a predetermined threshold value is not included in the first tag reading result,
a unit that confirms the first tag reading result,
a unit confirms a purchase product of the first person, based on the first tag reading result, and
a unit performs checkout processing of the purchase product of the first person.
27. The program according to any one of supplementary notes 22 to 26, further causing the computer to function as,

when a predetermined period of time has elapsed without the second person passing through the gate after the first person passes through the gate,
a unit that confirms the first tag reading result,
a unit that confirms a purchase product of the first person, based on the first tag reading result, and
a unit that performs checkout processing of the purchase product of the first person.
28. The program according to any one of supplementary notes 22 to 26,

wherein the gate including a human detection sensor on an entrance side,

the program further causes the computer to function as:

when the second person is not detected by the human detection sensor while the first person passes through the gate,
a unit that confirms the first tag reading result,
a unit that confirms a purchase product of the first person, based on the first tag reading result, and
a unit that performs checkout processing of the purchase product of the first person.
29. The store apparatus according to any one of supplementary notes 1 to 7, wherein

the reading result registration unit confirms the first tag reading result and the second tag reading result when a radio wave having intensity less than a predetermined threshold value is included in the first tag reading result, and a radio wave having intensity less than a predetermined threshold value is not included in the second tag reading result.
30. The store system according to any one of supplementary notes 8 to 14, wherein

the reading result registration unit confirms the first tag reading result and the second tag reading result when a radio wave having intensity less than a predetermined threshold value is included in the first tag reading result, and a radio wave having intensity less than a predetermined threshold value is not included in the second tag reading result.
31. The checkout method according to any one of supplementary notes 15 to 21, further including,

confirming the first tag reading result and the second tag reading result when a radio wave having intensity less than a predetermined threshold value is included in the first tag reading result, and a radio wave having intensity less than a predetermined threshold value is not included in the second tag reading result.
32. The program according to any one of supplementary notes 22 to 28, further causing the computer to function as

a unit that confirms the first tag reading result and the second tag reading result when a radio wave having intensity less than a predetermined threshold value is included in the first tag reading result, and a radio wave having intensity less than a predetermined threshold value is not included in the second tag reading result.

This application is based upon and claims the benefit of priority from Japanese patent application No. 2019-038667, filed on Mar. 4, 2019, the disclosure of which is incorporated herein in its entirety by reference.

What is claimed is:

1. A store apparatus, comprising:
a memory storing instructions; and
a processor configured to execute the instructions to:
register a tag reading result including tag recording information acquired by reading a tag provided to an individual product by a reading apparatus provided at a gate and intensity of a radio wave received from the tag, in association with person determination information that determines a person who passes through the gate;
confirm a purchase product, based on the tag reading result for each person;
perform checkout processing of the confirmed purchase product; and
issue an electronic receipt for the checkout processing, wherein,
the processor is further configured to execute the instructions to confirm, when tag recording information related to a same tag is included in both of a first tag reading result related to a first person and a second tag reading result related to a second person who passes through the gate after the first person the first tag reading result, based on magnitude of intensity of a radio wave received from the same tag.

2. The store apparatus according to claim 1, wherein
the processor is further configured to execute the instructions to perform correction processing of correcting either one of the first tag reading result and the second tag reading result, based on magnitude of intensity of a radio wave received from the same tag.

3. The store apparatus according to claim 2, wherein
the processor is further configured to execute the instructions to delete tag recording information related to the same tag being included in a tag reading result having smaller intensity of a radio wave received from the same tag between the first tag reading result and the second tag reading result.

4. The store apparatus according to claim 2, wherein
the processor is further configured to execute the instructions to perform the correction processing when a radio wave having intensity less than a predetermined threshold value is included in the first tag reading result.

5. The store apparatus according to claim 1, wherein,
when a radio wave having intensity less than a predetermined threshold value is not included in the first tag reading result, the processor is further configured to execute the instructions to:
confirm the first tag reading result;
confirm a purchase product of the first person, based on the first tag reading result; and
perform checkout processing of the purchase product of the first person.

6. The store apparatus according to claim 1, wherein,
when a predetermined period of time has elapsed without the second person passing through the gate after the first person passes through the gate, the processor is further configured to execute the instructions to:
confirm the first tag reading result;
confirm a purchase product of the first person, based on the first tag reading result; and
perform checkout processing of the purchase product of the first person.

7. The store apparatus according to claim 1, wherein
the gate includes a human detection sensor on an entrance side, and,
when the second person is not detected by the human detection sensor while the first person passes through the gate, the processor is further configured to execute the instructions to:
confirm the first tag reading result;
confirm a purchase product of the first person, based on the first tag reading result; and
perform checkout processing of the purchase product of the first person.

8. A store system, comprising:
a gate including a reading apparatus that reads a tag provided to an individual product;
a memory storing instructions; and
a processor configured to execute the instructions to:
register a tag reading result including tag recording information acquired by reading a tag provided to an individual product by the reading apparatus provided at the gate and intensity of a radio wave received from the tag, in association with person determination information that determines a person who passes through the gate;
confirm a purchase product, based on the tag reading result for each person;
perform checkout processing of the confirmed purchase product; and
issues issue an electronic receipt for the checkout processing, wherein,
the processor is further configured to execute the instructions to confirm, when tag recording information related to a same tag is included in both of a first tag reading result related to a first person and a second tag reading result related to a second person who passes through the gate after the first person, the first tag reading result, based on magnitude of intensity of a radio wave received from the same tag.

9. The store system according to claim 8, wherein
the processor is further configured to execute the instructions to perform correction processing of correcting either one of the first tag reading result and the second tag reading result, based on magnitude of intensity of a radio wave received from the same tag.

10. The store system according to claim 9, wherein
the processor is further configured to execute the instructions to delete tag recording information related to the same tag being included in a tag reading result having smaller intensity of a radio wave received from the same tag between the first tag reading result and the second tag reading result.

11. The store system according to claim 9, wherein
the processor is further configured to execute the instructions to perform the correction processing when a radio wave having intensity less than a predetermined threshold value is included in the first tag reading result.

12. The store system according to claim 8, wherein,
when a radio wave having intensity less than a predetermined threshold value is not included in the first tag reading result, the processor is further configured to execute the instructions to:
confirm the first tag reading result;
confirm a purchase product of the first person, based on the first tag reading result; and
perform checkout processing of the purchase product of the first person.

13. The store system according to claim 8, wherein,
when a predetermined period of time has elapsed without the second person passing through the gate after the first person passes through the gate, the processor is further configured to execute the instructions to:
confirm the first tag reading result;
confirm a purchase product of the first person, based on the first tag reading result; and
perform checkout processing of the purchase product of the first person.

14. The store system according to claim 8, wherein
the gate includes a human detection sensor on an entrance side, and,
when the second person is not detected by the human detection sensor while the first person passes through the gate, the processor is further configured to execute the instructions to:
confirm the first tag reading result;
confirm a purchase product of the first person, based on the first tag reading result; and
perform checkout processing of the purchase product of the first person.

15-21. (canceled)

22. A non-transitory computer readable storage medium storing a program for causing a computer to execute a checkout method, the checkout method comprising:
registering a tag reading result including tag recording information acquired by reading a tag provided to an individual product by a reading apparatus provided at a gate and intensity of a radio wave received from the tag, in association with person determination information that determines a person who passes through the gate;
confirming, when tag recording information related to a same tag is included in both of a first tag reading result related to a first person and a second tag reading result related to a second person who passes through the gate after the first person, the first tag reading result, based on magnitude of intensity of a radio wave received from the same tag;
confirming a purchase product, based on the tag reading result for each person;
performing checkout processing of the confirmed purchase product; and
issuing an electronic receipt for the checkout processing.

23-28. (canceled)

29. The store apparatus according to claim 1 wherein
the processor is further configured to execute the instructions to confirm the first tag reading result and the second tag reading result when a radio wave having intensity less than a predetermined threshold value is included in the first tag reading result, and a radio wave having intensity less than a predetermined threshold value is not included in the second tag reading result.

30-32. (canceled)
